(19) United States
(12) Patent Application Publication
(10) Pub. No.: US 2022/0091559 A1
(43) Pub. Date: Mar. 24, 2022

(54) HOLOGRAM RECORDING COMPOSITION, HOLOGRAM RECORDING MEDIUM, HOLOGRAM OPTICAL ELEMENT, OPTICAL DEVICE AND OPTICAL COMPONENT USING SAME, AND METHOD FOR FORMING HOLOGRAM DIFFRACTION GRATING

(71) Applicant: SONY GROUP CORPORATION, TOKYO (JP)

(72) Inventors: HISAYA HARA, TOKYO (JP); TAKAHIRO OHE, TOKYO (JP); ERI IGARASHI, TOKYO (JP); KENSHIRO KAWASAKI, TOKYO (JP); DAISUKE HOBARA, TOKYO (JP)

(21) Appl. No.: 17/424,770

(22) PCT Filed: Jan. 7, 2020
(86) PCT No.: PCT/JP2020/000096

§ 371 Date: Jul. 21, 2021

(30) Foreign Application Priority Data
Jan. 31, 2019 (JP) 2019-015911

(51) Int. Cl. G03H 1/02; G11B 7/24044; G11B 7/246; G11B 7/245; G02B 5/32; C08F 2/50

(52) U.S. Cl. CPC G03H 1/024; G11B 7/24044; G11B 7/246; G03H 2001/0264; G02B 5/32; C08F 2/50; G03H 2260/12; G11B 7/245

(57) ABSTRACT

To provide a hologram recording composition capable of further improving diffraction characteristics and the transparency of a hologram.

The present technology provides a hologram recording composition containing at least a chromic dye whose decolorized body has a structure containing a primary and/or secondary amino group, an epoxy monomer, and a polymerization initiator. The present technology also provides a hologram recording medium including a photosensitive layer containing at least a chromic dye whose decolorized body has a structure containing a primary and/or secondary amino group, an epoxy monomer, and a polymerization initiator. Furthermore, the present technology also provides a hologram optical element using the hologram recording medium. Moreover, the present technology also provides an optical device and an optical component using the hologram optical element. The present technology also provides a method for forming a hologram diffraction grating, the method including causing the hologram recording medium to react selectively by an electromagnetic beam having a spatially modulated amplitude.

### TECHNICAL FIELD

The present technology relates to a hologram recording composition, a hologram recording medium, a hologram optical element, an optical device and an optical component using the same, and a method for forming a hologram diffraction grating.

### BACKGROUND ART

A hologram is obtained by recording a light-dark (interference) pattern of light on a photosensitive material and the like as a pattern of a refractive index and the like, and is widely used in a field such as optical information processing, security, medicine, or a head-up display. The hologram is attracting attention as a next-generation recording medium because of being able to record three-dimensional information about an object as optical information in a large capacity.

So far, various proposals have been made for materials for the hologram. For example, Patent Document 1 proposes a transparent hologram photosensitive recording material to obtain a volume phase type transparent hologram by holographic exposure, the transparent hologram photosensitive recording material mainly containing: a resin that is solvent-soluble and solid at room temperature and normal pressure; a polymerizable monomer that is liquid at room temperature and normal pressure, has a boiling point of 100° C. or higher at normal pressure, has at least one radically polymerizable ethylenically unsaturated bond, and has a different refractive index from the resin; a first photoinitiator that generates a radical species that activates radical polymerization when being exposed to chemical action radiation and a Broensted acid or a Lewis acid at the same time, or a second photoinitiator containing a radical polymerization initiator that generates a radical species that activates radical polymerization when being exposed to chemical action radiation and a cationic polymerization initiator that generates a Broensted acid or a Lewis acid when being exposed to chemical action radiation; a sensitizing dye that sensitizes the first photoinitiator or the second photoinitiator and has an amino group; and a compound that generates a sulfonic acid derivative by an action of the Broensted acid or the Lewis acid to fade or decolorize the sensitizing dye.

Furthermore, Patent Document 2 proposes a volume hologram recording photosensitive composition containing (a) a radically polymerizable compound having a specific structure, (b) a photopolymerization initiator, and (c) a compound having a different refractive index from the radically polymerizable compound, characterized by containing 10 to 95% by weight of the radically polymerizable compound (a).

### CITATION LIST

### Patent Document

### Patent Document 1: Japanese Patent Application Laid-Open No. 08-305262

### Patent Document 2: Japanese Patent Application Laid-Open No. 2001-125474

### SUMMARY OF THE INVENTION

### Problems to be Solved by the Invention

However, in hologram technology, it is required to further improve diffraction characteristics and the transparency of a hologram. Therefore, a main object of the present technology is to provide a hologram recording composition capable of improving diffraction characteristics and the transparency of a hologram, a hologram recording medium, a hologram optical element, an optical device and an optical component using the same, and a method for forming a hologram diffraction grating.

### Solutions to Problems

The present inventors made intensive studies in order to solve the above-described problem, and as a result, have succeeded in further improving diffraction characteristics and the transparency of a hologram, and have completed the present technology.

That is, the present technology provides a hologram recording composition containing at least a chromic dye whose decolorized body has a structure containing a primary and/or secondary amino group, an epoxy monomer, and a polymerization initiator.

The chromic dye may be a dye that is decolorized by pH and/or redox.

The hologram recording composition may contain two or more of the polymerization initiators.

The polymerization initiator may contain one or more onium salt-based initiators.

The polymerization initiator may contain one or more onium salt-based initiators and one or more non-onium salt-based initiators.

The polymerization initiator may contain one or more onium salt-based initiators and one or more aryl borate salt-based initiators.

The chromic dye may be at least one selected from the group consisting of a thiazine-based compound, an azine-based compound, an acridine-based compound, an oxazine-based compound, and a cyanine-based compound.

Furthermore, the present technology provides a hologram recording medium including a photosensitive layer containing at least a chromic dye whose decolorized body has a structure containing a primary and/or secondary amino group, an epoxy monomer, and a polymerization initiator.

The chromic dye may be a dye that is decolorized by pH and/or redox.

The photosensitive layer may contain two or more of the polymerization initiators.

The polymerization initiator may contain one or more onium salt-based initiators.

The polymerization initiator may contain one or more onium salt-based initiators and one or more non-onium salt-based initiators.

The polymerization initiator may contain one or more onium salt-based initiators and one or more aryl borate salt-based initiators.

The chromic dye may be at least one selected from the group consisting of a thiazine-based compound, an azine-based compound, an acridine-based compound, an oxazine-based compound, and a cyanine-based compound.

Moreover, the present technology also provides a hologram optical element using the hologram recording medium.

The present technology also provides an optical device using the hologram optical element.

Furthermore, the present technology also provides an optical component using the hologram optical element.

Moreover, the present technology also provides a method for forming a hologram diffraction grating, the method including causing a hologram recording medium including a photosensitive layer containing at least a chromic dye whose decolorized body has a structure containing a primary and/or secondary amino group, an epoxy monomer, and a polymerization initiator to react selectively by an electromagnetic beam having a spatially modulated amplitude.

### BRIEF DESCRIPTION OF DRAWINGS

FIG. 1 is a cross-sectional view schematically illustrating an example of a hologram recording medium according to an embodiment of the present technology.

### MODE FOR CARRYING OUT THE INVENTION

Hereinafter, a preferable embodiment for carrying out the present technology will be described. Note that the embodiments described below exemplify typical embodiments of the present technology, and the scope of the present technology is not limited to the embodiments.

Note that the present technology will be described in the following order.

1. Summary of the present technology

2. First embodiment (hologram recording composition)

2-1. Hologram recording composition

2-2. Chromic dye

2-3. Epoxy monomer

2-4. Polymerization initiator

2-5. Other components

2-6. Method for manufacturing hologram recording composition

3. Second embodiment (hologram recording medium)

3-1. Hologram recording medium

3-2. Photosensitive layer

3-3. Transparent base material

3-4. Method for manufacturing hologram recording medium

4. Third embodiment (hologram optical element)

4-1. Hologram optical element

4-2. Method for manufacturing hologram optical element

5. Fourth embodiment (optical device and optical component)

6. Fifth embodiment (method for forming hologram diffraction grating)

### 1. SUMMARY OF THE PRESENT TECHNOLOGY

First, summary of the present technology will be described.

The present technology relates to a hologram recording composition, a hologram recording medium, a hologram optical element, an optical device and an optical component using the same, and a method for forming a hologram diffraction grating.

In recent years, application of a hologram to a see-through displays and the like has been expected. A hologram for a see-through display is required to have a high refractive index modulation amount (Δn) and excellent transparency and retention of diffraction characteristics after exposure. On the other hand, in order to obtain a high refractive index modulation amount (Δn), it is indispensable to go through a heating step after interference exposure, which has been a factor in complicating a process. Furthermore, in a method for forming a hologram, the method including going through a heating step after interference exposure, it is not possible to use a base material having low heat resistance.

As a material for a hologram, for example, a technique for improving retention of diffraction characteristics using a thermosetting plasticizer (epoxy oligomer), and moreover, decolorizing an amine-based sensitizing dye that can be decolorized with an acid after interference exposure with the acid to increase transparency has been proposed. However, in this technique, heating is performed after interference exposure, and the refractive index modulation amount (Δn) is less than 0.02. Moreover, since the sensitizing dye is decolorized with a strong acid such as sulfonic acid, a hologram recording medium needs to have high acid resistance, and there is a concern about long-term deterioration of the hologram due to the acid.

On the other hand, a technique for improving the refractive index modulation amount (Δn) and the retention of diffraction characteristics using an acrylic monomer and a cationically polymerizable compound (epoxy monomer and the like) without going through a heating step after exposure has also been proposed. However, with this technique, a sensitizing dye is not sufficiently decolorized, and a hologram having excellent transparency cannot be obtained in some cases.

As described above, with the conventional techniques, it is difficult to obtain a hologram having a high refractive index modulation amount (Δn) and excellent transparency and retention of diffraction characteristics after exposure without going through a heating step after exposure.

As a result of various studies, the present inventors have found that by combining a chromic dye whose decolorized body has a structure containing a primary and/or secondary amino group with an epoxy monomer, the primary and/or secondary amino group of the decolorized body of the chromic dye reacts with the epoxy monomer, the structure of the decolorized body is fixed (formed into an irreversible structure), a decolorization reaction of the chromic dye proceeds favorably, and therefore transparency of a hologram can be improved. In addition, the present inventors have found that by combining the chromic dye, the epoxy monomer, and a polymerization initiator, a hologram having a high refractive index modulation amount (Δn) and excellent transparency and retention of diffraction characteristics after exposure can be obtained without going through a heating step after exposure.

That is, by combining a chromic dye whose decolorized body has a structure containing a primary and/or secondary amino group, an epoxy monomer, and a polymerization initiator as materials for a hologram, the present technology can provide a hologram recording composition having excellent diffraction characteristics and transparency without going through a heating step after exposure, a hologram recording medium, a hologram optical element, an optical device and an optical component using the same, and a method for forming a hologram diffraction grating.

### 2. FIRST EMBODIMENT (HOLOGRAM RECORDING COMPOSITION)

[2-1. Hologram Recording Composition] A hologram recording composition according to a first embodiment of the present technology is a hologram recording composition containing at least a chromic dye whose decolorized body has a structure containing a primary and/or secondary amino group, an epoxy monomer, and a polymerization initiator.

According to the hologram recording composition according to the first embodiment of the present technology, a hologram having a high refractive index modulation amount (Δn), and having excellent transparency and retention of diffraction characteristics after exposure without going through a heating step after exposure can be obtained. Hereinafter, each component will be described in detail.

[2-2. Chromic Dye]

The structure of a decolorized body of the chromic dye contained in the hologram recording composition according to the present embodiment contains a primary and/or secondary amino group. By using the chromic dye, the sensitivity of a polymerization initiator described later to light can be sensitized. Furthermore, the structure of a decolorized body of the chromic dye contains a primary and/or secondary amino group, and therefore reacts with an epoxy monomer described later and is fixed (formed into an irreversible structure). Therefore, the transparency of an obtained hologram can be made favorable.

The chromic dye in the present embodiment may be a dye that is decolorized by temperature, light, electric field, magnetic field, pressure, pH, redox, solvation, isomerization, orientation, and the like. Among these, the chromic dye is preferably a dye that is decolorized by pH and/or redox. By using the chromic dye that is decolorized by pH and/or redox, the sensitivity during hologram recording and the decolorization property after exposure can be both easily obtained. Therefore, the effect of the present technology is more exhibited.

Furthermore, the chromic dye in the present embodiment is preferably at least one selected from the group consisting of a thiazine-based compound, an azine-based compound, an acridine-based compound, an oxazine-based compound, and a cyanine-based compound. By using a chromic dye having any of these skeletons, the sensitivity during hologram recording and the decolorization property after exposure can be both easily obtained. Therefore, the effect of the present technology is more exhibited.

Specific examples of the chromic dye in the present embodiment include methylene blue, safranin o, astrazon orange G, acridine orange, acridine yellow, thionin, toluidine blue o, and neutral red, but are not limited thereto.

The content of the chromic dye in the hologram recording composition may be appropriately set by those skilled in the art, but is preferably 0.001 to 50% by mass, and more preferably 0.01 to 10% by mass with respect to the total mass of the hologram recording composition.

[2-3. Epoxy Monomer]

The epoxy monomer contained in the hologram recording composition according to the present embodiment is effective as a plasticizer for adjusting the adhesiveness, flexibility, hardness, and other physical characteristics of the hologram recording composition. Furthermore, the epoxy monomer reacts with a decolorized body of the above-described chromic dye, and the structure of the decolorized body of the chromic dye is fixed (formed into an irreversible structure). Therefore, the transparency of an obtained hologram can be made favorable. Moreover, since the epoxy monomer can be cured after exposure, retention of diffraction characteristics of an obtained hologram can be made favorable.

As the epoxy monomer in the present embodiment, for example, glycidyl ether and the like can be used. Specific examples of the glycidyl ether include allyl glycidyl ether, phenyl glycidyl ether, 1,4-butanediol diglycidyl ether, 1,5-pentanediol diglycidyl ether, 1,6-hexanediol diglycidyl ether, 1,8-octanediol diglycidyl ether, 1,10-decanediol diglycidyl ether, 1,12-dodecanediol diglycidyl ether, ethylene glycol diglycidyl ether, diethylene glycol diglycidyl ether, polyethylene glycol diglycidyl ether, polypropylene glycol diglycidyl ether, neopentyl glycol diglycidyl ether, bisphenol A diglycidyl ether, bisphenol F diglycidyl ether, trimethylolpropane diglycidyl ether, glycerin triglycidyl ether, diglycerol triglycidyl ether, sorbitol polyglycidyl ether, and pentaerythritol polyglycidyl ether, but are not limited thereto.

[2-4. Polymerization Initiator]

The hologram recording composition according to the present embodiment contains a polymerization initiator. The polymerization initiator in the present embodiment preferably contains one or more photopolymerization initiators, and may further contain one or more thermal polymerization initiators.

The hologram recording composition according to the present embodiment may contain one polymerization initiator, or may contain two or more polymerization initiators. The polymerization initiator preferably contains one or more onium salt-based initiators, and more preferably contains the above one or more onium salt-based initiators and one or more non-onium salt-based initiators. Furthermore, the polymerization initiator still more preferably contains the above one or more onium salt-based initiators and one or more aryl borate salt-based initiators.

By using the onium salt-based initiator as the polymerization initiator in the present embodiment, a polymerization initiation effect during hologram recording and an effect of improving the decolorizing property of the chromic dye after exposure can be made more favorable, and the effect of the present technology is more exhibited. Furthermore, by using the onium salt-based initiator and the aryl borate salt-based initiator in combination, a polymerization initiation effect during hologram recording and an effect of improving the decolorizing property of the chromic dye after exposure can be made still more favorable, and the effect of the present technology is still more exhibited.

Examples of the onium salt-based initiator include a diazonium salt, an iodonium salt, a sulfonium salt, a phosphonium salt, and a bismuthonium salt. Furthermore, examples of an anion of the onium salt include PF₆⁻, SbF₆⁻, and B(C₆F₅)₄⁻.

Examples of the aryl borate salt-based initiator include a diaryl borate salt, a triaryl borate salt, and a tetraaryl borate salt. Among these compounds, a triaryl borate salt is preferably used. Furthermore, examples of a cation of the aryl borate salt include tetraalkylammonium.

In a preferable aspect, the hologram recording composition according to the present embodiment contains at least the above-described chromic dye, epoxy monomer, onium salt-based initiator, and triaryl borate salt-based initiator.

The content of the polymerization initiator in the hologram recording composition may be appropriately set by those skilled in the art, but is preferably 0.1 to 50% by mass, and more preferably 1 to 20% by mass with respect to the total mass of the hologram recording composition.

[2-5. Other Components]

The hologram recording composition recording of the present embodiment may contain a radically polymerizable monomer, a binder resin, a chain transfer agent, a polymerization inhibitor, a UV sensitizer, a solvent, and the like in addition to the above-described components.

Examples of the radically polymerizable monomer include monofunctional, bifunctional, trifunctional, and polyfunctional acrylate monomers; a methacrylate monomer; and urethane acrylate, and one or more of these can be used. More specific examples thereof include bisphenoxyethanol fluorene diacrylate.

The binder resin can be effective for improving film strength, heat resistance, and mechanical strength.

Examples of the binder resin include a vinyl acetate-based resin such as polyvinyl acetate or a hydrolyzate thereof; an acrylic resin such as poly (meth)acrylate or a partial hydrolyzate thereof; polyvinyl alcohol or a partial acetal product thereof; triacetylcellulose; polyisoprene; polybutadiene; polychloroprene; silicone rubber; polystyrene; polyvinyl butyral; polychloroprene; polyvinyl chloride; polyarylate; chlorinated polyethylene; chlorinated polypropylene; poly-N-vinylcarbazole or a derivative thereof; poly-N-vinylpyrrolidone or a derivative thereof; polyarylate; a copolymer of styrene and maleic anhydride or a semiester thereof; and a copolymer containing, as a polymerization component, at least one of copolymerizable monomers such as acrylic acid, acrylate, methacrylic acid, methacrylate, acrylamide, acrylnitrile, ethylene, propylene, vinyl chloride, and vinyl acetate, and one or more of these can be used. Moreover, as the copolymerization component, a monomer containing a thermosetting or photocurable functional group can also be used.

Furthermore, as the binder resin, an oligomer type curable resin can also be used. Examples thereof include epoxy compounds generated by a condensation reaction between various phenol compounds such as bisphenol A, bisphenol S, novolak, o-cresol novolak, and p-alkylphenol novolak, and epichlorohydrin, and one or more of these compounds can be used.

The chain transfer agent can abstract a radical from a growth end in a polymerization reaction to stop growth and becomes a new polymerization reaction initiator species, which is added to the radically polymerizable monomer to be able to start growth of a new polymer. Use of the chain transfer agent increases the frequency of chain transfer of radical polymerization. As a result, the reaction rate of the radically polymerizable monomer is increased, and the sensitivity to light can be improved. Furthermore, the reaction rate of the radically polymerizable monomer is increased, and reaction contributing components are increased. Therefore, the degree of polymerization of the radically polymerizable monomer can be adjusted.

Examples of the chain transfer agent include α-methylstyrene dimer, 2-mercaptobenzoxazole, 2-mercaptobenzothiazole, tert-butyl alcohol, n-butanol, isobutanol, isopropylbenzene, ethylbenzene, chloroform, methylethylketone, propylene, and vinyl chloride. One or more of these can be used.

Examples of the polymerization inhibitor include a quinone-based compound such as hydroquinone; a hindered phenol-based compound; a benzotriazole compound; and a thiazine-based compound such as phenothiazine. One or more of these may be used.

As the UV sensitizer, for example, an anthracene-based compound and the like can be used.

The solvent can be effective for adjusting viscosity and compatibility, improving a film-forming property, and the like.

Examples of the solvent include acetone, xylene, toluene, methyl ethyl ketone, tetrahydrofuran, benzene, methylene chloride, dichloromethane, chloroform, and methanol. One or more of these can be used.

[2-6. Method for Manufacturing Hologram Recording Composition]

The hologram recording composition according to the first embodiment of the present technology can be manufactured, for example, by adding a chromic dye, an epoxy monomer, and a polymerization initiator in predetermined amounts to the above-described solvent at room temperature or the like, and dissolving and mixing the chromic dye, the epoxy monomer, and the photopolymerization initiator. Furthermore, the above-described radically polymerizable monomer, binder resin, chain transfer agent, polymerization inhibitor, UV sensitizer, and the like may be added depending on an intended use, a purpose, and the like. In a case where the hologram recording composition according to the first embodiment of the present technology is used for a hologram recording medium described later, the hologram recording composition may be used as a coating liquid.

### 3. SECOND EMBODIMENT (HOLOGRAM RECORDING MEDIUM)

[3-1. Hologram Recording Medium] A hologram recording medium according to a second embodiment of the present technology is a hologram recording medium including a photosensitive layer containing at least a chromic dye whose decolorized body has a structure containing a primary and/or secondary amino group, an epoxy monomer, and a polymerization initiator. The hologram recording medium according to the present embodiment contains the hologram recording composition according to the first embodiment of the present technology.

The hologram recording medium according to the present embodiment may include the photosensitive layer and at least one transparent base material, and the photosensitive layer may be formed on the at least one transparent base material.

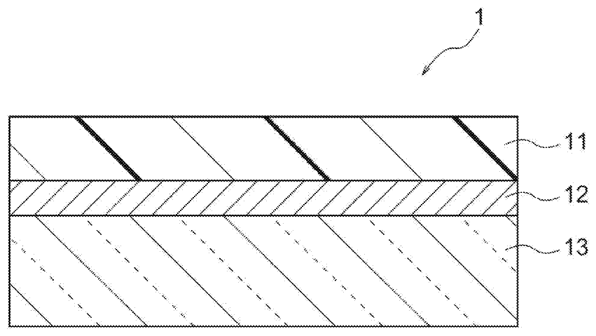

Here, FIG. 1 illustrates a schematic cross-sectional view of an example of the hologram recording medium according to the present embodiment. A hologram recording medium 1 illustrated has a three-layer structure in which a photosensitive layer 12 is disposed between a transparent protective film 11 (transparent base material) and a glass or film substrate (transparent base material) 13. As described above, the hologram recording medium according to the present embodiment may have a three-layer structure in which a photosensitive layer is formed on a first transparent base material, and moreover a second transparent base material is formed on a main surface of the photosensitive layer on which the first transparent base material is not formed.

According to the hologram recording medium according to the second embodiment of the present technology, a hologram having a high refractive index modulation amount (Δn), and having excellent transparency and retention of diffraction characteristics after exposure without going through a heating step after exposure can be obtained.

[3-2. Photosensitive Layer]

The photosensitive layer included in the hologram recording medium according to the second embodiment of the present technology contains at least a chromic dye whose decolorized body has a structure containing a primary and/or secondary amino group, an epoxy monomer, and a polymerization initiator. The photosensitive layer contains materials of the hologram recording composition according to the first embodiment of the present technology, and all the contents described for each of the materials in the above section 2 also apply to the photosensitive layer of the hologram recording medium in the present embodiment. The photosensitive layer of the hologram recording medium may be constituted by the hologram recording composition according to the first embodiment of the present technology and other materials, or may be constituted by the hologram recording composition according to the first embodiment of the present technology.

The thickness of the photosensitive layer of the hologram recording medium according to the present embodiment may be appropriately set by those skilled in the art, but is preferably 0.1 to 100 μm, and more preferably 1 to 30 μm from a viewpoint of diffraction efficiency and sensitivity to light.

[3-3. Transparent base material] The hologram recording medium according to the second embodiment of the present technology may contain at least one transparent base material. As the transparent base material, a glass substrate, a transparent resin substrate, and the like may be used.

Specific examples of the transparent resin substrate include a polyester film such as a polyethylene film, a polypropylene film, a polyethylene fluoride-based film, a polyvinylidene fluoride film, a polyvinyl chloride film, a polyvinylidene chloride film, an ethylene-vinyl alcohol film, a polyvinyl alcohol film, a polymethyl methacrylate film, a polyether sulfone film, a polyether ether ketone film, a polyamide film, a tetrafluoroethylene-perfluoroalkyl vinyl copolymer film, or a polyethylene terephthalate film; and a polyimide film.

The thickness of the transparent base material of the hologram recording medium according to the present embodiment may be appropriately set by those skilled in the art, but is preferably 0.1 to 100 μm, and more preferably 1 to 30 μm from a viewpoint of transparency and rigidity of the hologram recording medium. The film exemplified above can be used as a protective film of the hologram recording medium, and the film can be laminated on a coated surface. In this case, a contact surface between the laminate film and the coated surface may be subjected to a mold release treatment such that the film can be easily peeled off later.

[3-4. Method for Manufacturing Hologram Recording Medium]

The hologram recording medium according to the second embodiment of the present technology can be obtained, for example, by applying a coating liquid constituted by the hologram recording composition described in the above section 2 onto a transparent base material using a spin coater, a gravure coater, a comma coater, a bar coater, and the like, and then drying the coating liquid to form a photosensitive layer.

### 4. THIRD EMBODIMENT (HOLOGRAM OPTICAL ELEMENT)

[4-1. Hologram Optical Element]

A hologram optical element according to a third embodiment of the present technology is obtained by using the hologram recording medium according to the second embodiment of the present technology. The hologram optical element according to the present embodiment can be obtained, for example, by exposing the above hologram recording medium to light by a method described later. The hologram optical element contains at least, for example, a decolorized body of a chromic dye, a polymer and/or an oligomer containing a structural unit derived from an epoxy monomer, and a product obtained by a structural change of a polymerization initiator by generation of an active species due to irradiation with external energy.

The hologram optical element according to the third embodiment of the present technology has a high refractive index modulation amount (Δn), and has excellent transparency and retention of diffraction characteristics after exposure without going through a heating step after exposure. Hereinafter, an example of a reaction mechanism that is assumed during exposure will be specifically described.

In a case where a hologram optical element is obtained from a hologram recording medium obtained using a hologram recording composition containing at least methylene blue, an epoxy monomer, an onium salt-based initiator, and a triaryl borate salt-based initiator as the hologram recording composition according to the first embodiment of the present technology, an example of a reaction mechanism that is assumed will be described.

When the hologram recording medium is exposed to light and light is incident on the photosensitive layer, a part of methylene blue excited by the light is reduced by the triaryl borate salt and decolorized. Since the decolorized body of methylene blue has a secondary amino group, a part of the decolorized body of methylene blue reacts with the epoxy monomer, and the structure of the decolorized body is fixed (formed into an irreversible structure). On the other hand, a concerted reaction also occurs in which a part of the decolorized body of methylene blue is reoxidized (recolored) by the onium salt, and a radical and an acid are generated.

In the hologram recording medium, two active species are generated from the onium salt and the triaryl borate salt by excitation of one molecule of methylene blue. Therefore, it is conceivable that photon efficiency is also high and a high refractive index modulation amount (Δn) can be obtained.

Furthermore, in the hologram recording medium, the acid generated by the concerted reaction gradually cures the epoxy monomer having an effect of promoting material separation after a hologram is formed. Therefore, it is conceivable that the retention of diffraction characteristics can be improved.

Furthermore, in the hologram recording medium, the structure of the decolorized body of the chromic dye is fixed (formed into an irreversible structure) by the reaction between the chromic dye and the epoxy monomer, and the decolorizing reaction of the chromic dye proceeds favorably. Therefore, it is conceivable that transparency can be improved. Moreover, since the concentration of the sensitizing dye (methylene blue) can be made lower than that of a conventional hologram material that does not go through a heating step after exposure. Therefore, it is conceivable that transparency can be further improved.

[4-2. Method for Manufacturing Hologram Optical Element]

The hologram optical element according to the third embodiment of the present technology can be obtained, for example, by exposing the hologram recording medium according to the second embodiment of the present technology to two light fluxes using a semiconductor laser in a visible light region, then irradiating the entire surface with (ultraviolet rays) UV to cure an uncured epoxy monomer and the like, and fixing a refractive index distribution to the hologram recording medium. Conditions for the exposure with two light fluxes may be appropriately set by those skilled in the art according to an intended use, a purpose, and the like of the hologram optical element. However, it is desirable to perform exposure preferably for 1 to 1000 seconds by setting the light intensity of one light flux on the hologram recording medium to 0.1 to 100 mW/cm², and to perform interference exposure such that an angle between the two light fluxes is 0.1 to 179.9 degrees.

### 5. FOURTH EMBODIMENT (OPTICAL DEVICE AND OPTICAL COMPONENT)

An optical device and an optical component according to a fourth embodiment of the present technology use the hologram optical element according to the third embodiment of the present technology.

Examples of the optical device and the optical component include an image display device such as an eyewear, a holographic screen, a transparent display, a head mount display, or a head-up display, an imaging device, an imaging element, a color filter, a diffractive lens, a light guide plate, a spectroscopic element, a hologram sheet, an information recording medium such as an optical disk or a magneto-optical disk, an optical pickup device, a polarizing microscope, and a sensor.

The optical device and the optical component according to the fourth embodiment of the present technology each use a hologram optical element having excellent diffraction characteristics and transparency. Therefore, it is possible to achieve an optical device and an optical component each having high optical characteristics and optical stability. Moreover, in a case where the present technology is used for a display, a display having a high see-through property can be obtained.

### 6. FIFTH EMBODIMENT (METHOD FOR FORMING HOLOGRAM DIFFRACTION GRATING)

The present technology provides a method for forming a hologram diffraction grating, the method including causing a hologram recording medium including a photosensitive layer containing at least a chromic dye whose decolorized body has a structure containing a primary and/or secondary amino group, an epoxy monomer, and a polymerization initiator to react selectively by an electromagnetic beam having a spatially modulated amplitude. The method for forming a hologram diffraction grating is the interference exposure described in the above section 4-2. Therefore, description of the method for forming a hologram diffraction grating will be omitted. According to the method for forming a hologram diffraction grating, the effect as described in the above section 4 is exhibited.

Note that the embodiments of the present technology are not limited to the above-described embodiments, and various modifications can be made thereto without departing from the gist of the present technology.

Furthermore, the effects described here are merely examples, and the effects of the present technology are not limited thereto, and may include other effects.

Note that the present technology may have the following configurations.

[1]

A hologram recording composition containing at least a chromic dye whose decolorized body has a structure containing a primary and/or secondary amino group, an epoxy monomer, and a polymerization initiator.

[2]

The hologram recording composition according to [1], in which the chromic dye is a dye that is decolorized by pH and/or redox.

[3]

The hologram recording composition according to [1] or [2], containing two or more of the polymerization initiators.

[4]

The hologram recording composition according to any one of [1] to [3], in which the polymerization initiator contains one or more onium salt-based initiators.

[5]

The hologram recording composition according to any one of [1] to [4], in which the polymerization initiator contains one or more onium salt-based initiators and one or more non-onium salt-based initiators.

[6]

The hologram recording composition according to any one of [1] to [5], in which the polymerization initiator contains one or more onium salt-based initiators and one or more aryl borate salt-based initiators.

[7]

The hologram recording composition according to any one of [1] to [6], in which the chromic dye is at least one selected from the group consisting of a thiazine-based compound, an azine-based compound, an acridine-based compound, an oxazine-based compound, and a cyanine-based compound.

[8]

A hologram recording medium including a photosensitive layer containing at least a chromic dye whose decolorized body has a structure containing a primary and/or secondary amino group, an epoxy monomer, and a polymerization initiator.

[9]

The hologram recording medium according to [8], in which the chromic dye is a dye that is decolorized by pH and/or redox.

[10]

The hologram recording medium according to [8] or [9], in which the photosensitive layer contains two or more of the polymerization initiators.

[11]

The hologram recording medium according to any one of [8] to [10], in which the polymerization initiator contains one or more onium salt-based initiators.

[12]

The hologram recording medium according to any one of [8] to [11], in which the polymerization initiator contains one or more onium salt-based initiators and one or more non-onium salt-based initiators.

[13]

The hologram recording medium according to any one of [8] to [12], in which the polymerization initiator contains one or more onium salt-based initiators and one or more aryl borate salt-based initiators.

[14]

The hologram recording medium according to any one of [8] to [13], in which the chromic dye is at least one selected from the group consisting of a thiazine-based compound, an azine-based compound, an acridine-based compound, an oxazine-based compound, and a cyanine-based compound.

[15]

A hologram optical element using the hologram recording medium according to any one of [8] to [14].

[16]

An optical device using the hologram optical element according to [15].

[17]

An optical component using the hologram optical element according to [15].

[18]

A method for forming a hologram diffraction grating, the method including causing a hologram recording medium including a photosensitive layer containing at least a chromic dye whose decolorized body has a structure containing a primary and/or secondary amino group, an epoxy monomer, and a polymerization initiator to react selectively by an electromagnetic beam having a spatially modulated amplitude.

### EXAMPLES

Hereinafter, the effects of the present technology will be specifically described with reference to Examples. Note that the scope of the present technology is not limited to the Examples.

### Example 1

(Preparation of Hologram Recording Composition 1)

According to the amounts illustrated in Table 1 below, bisphenoxyethanol fluorene diacrylate (“EA-0200” manufactured by Osaka Gas Chemicals Co., Ltd.) and 2-(9H-carbazol-9-yl) ethyl acrylate (“EACz” manufactured by SIGMA ALDRICH) as radically polymerizable monomers, polyvinyl acetate (“SN-09T” manufactured by Denka Company Limited) as a binder resin, 1,6-hexanediol diglycidyl ether (“EX-212L” manufactured by Nagase ChemteX Corporation) as a plasticizer, methylene blue (“MB” manufactured by Tokyo Chemical Industry Co., Ltd.) as a chromic dye, 4-isopropyl-4′-methyldiphenyliodonium tetrakis(pentafluorophenyl) borate (“10591” manufactured by Tokyo Chemical Industry Co., Ltd.) and tetrabutylammonium=butyltriphenylborate (“P3B” manufactured by Showa Denko K.K.) as polymerization initiators, 2-mercaptobenzoxazole (“2-MBO” manufactured by Tokyo Chemical Industry) as a chain transfer agent, phenothiazine (“PT” manufactured by Wako Pure Chemical Industries, Ltd.) as a polymerization inhibitor, and 9,10-dibutoxyanthracene (“UVS1331” manufactured by Kawasaki Kasei Chemicals Ltd.) as a UV sensitizer were mixed in an acetone solvent at room temperature to prepare a hologram recording composition 1.

(Preparation of Hologram Recording Medium 1)

The hologram recording composition 1 was applied onto a polyvinyl alcohol film having a thickness of 2.5 μm with a bar coater so as to have a dry film thickness of 3 μm. Subsequently, a thin film surface of the photosensitive layer was pressure-bonded onto a glass substrate having a thickness of 1.0 mm to obtain a hologram recording medium 1 formed by laminating the glass substrate, the photosensitive layer, and the polyvinyl alcohol film in this order.

(Preparation of Hologram 1)

The above hologram recording medium 1 was exposed to two light fluxes at an exposure amount of 510 mJ/cm² using a semiconductor laser with an exposure wavelength of 660 nm. Thereafter, the entire surface was irradiated with ultraviolet rays (UV) to cure an uncured monomer, and a refractive index distribution was fixed to the medium 1. As conditions of the exposure with two light fluxes, the exposure was performed for 53.1 seconds by setting the light intensity of one light flux on the recording medium to 4.8 mW/cm², and interference exposure was performed such that an angle between the two light fluxes was 3.0 degrees. As a result, a refractive index distribution was formed on the hologram recording medium 1 to obtain a hologram 1.

(Evaluation of Hologram 1)

The refractive index modulation amount (Δn), the transparency, and the retention of diffraction characteristics of the prepared hologram 1 were evaluated by the following methods.

The refractive index modulation amount (Δn) was evaluated using Kogelnik's coupled wave theory (Bell System Technical Journal, 48, 2909 (1969)) from a maximum transmittance and a half value of width of a transmittance spectrum obtained by incidence on the hologram. The transmittance spectrum was obtained by measuring a transmittance at 400 to 700 nm using a spot light source manufactured by Hamamatsu Photonics Co., Ltd. as a light source and a small fiber optical spectroscope USB-4000 manufactured by Ocean Optics Co., Ltd. as a spectroscope.

The transparency of the obtained hologram 1 was evaluated visually. In a case where coloring was not observed, the transparency was evaluated as “∘”, and in a case where coloring was observed, the transparency was evaluated as “x”.

As for the retention of diffraction characteristics, the obtained hologram 1 was allowed to stand in an environment of 60° C. and humidity of 80% for 100 hours, and a change in the tint of diffracted light was visually evaluated. In a case where a change in the tint was not observed after the test as compared with the tint before the test, the hologram 1 was evaluated as “∘”, and in a case where a change in the tint was observed after the test as compared with the tint before the test, the hologram 1 was evaluated as “x”.

### Examples 2 to 5

(Preparation of Hologram Recording Compositions 2 to 5)

In Example 2, a hologram recording composition 2 was obtained according to the amounts illustrated in Table 1 in a similar manner to Example 1 using similar materials to those in Example 1 except that polyvinyl acetate (“SN-55T” manufactured by Denka Company Limited) was used as a binder resin.

In Example 3, a hologram recording composition 3 was obtained according to the amounts illustrated in Table 1 in a similar manner to Example 1 using similar materials to those in Example 1 except that polyvinyl acetate (“SN-55T” manufactured by Denka Company Limited) was used as a binder resin.

In Example 4, a hologram recording composition 4 was obtained according to the amounts illustrated in Table 1 in a similar manner to Example 1 using similar materials to those in Example 1 except that polyvinyl acetate (“SN-77T” manufactured by Denka Company Limited) was used as a binder resin, safranin o (“SFO” manufactured by SIGMA ALDRICH) was used as a chromic dye, and no chain transfer agent was used.

In Example 5, a hologram recording composition 5 was obtained according to the amounts illustrated in Table 1 in a similar manner to Example 1 using similar materials to those in Example 1 except that astrazon orange G (“AOG” manufactured by SIGMA ALDRICH) was used as a chromic dye.

(Preparation of Hologram Recording Media 2 to 5)

Hologram recording media 2 to 5 were prepared in a similar manner to Example 1 using the above hologram recording compositions 2 to 5, respectively.

(Preparation of Holograms 2 to 5)

Holograms 2 to 5 were prepared in a similar manner to Example 1 using the above hologram recording media 2 to 5, respectively.

(Evaluation of Holograms 2 to 5)

The refractive index modulation amount (Δn), the transparency, and the retention of diffraction characteristics of each of the prepared holograms 2 to 5 were evaluated in a similar manner to Example 1.

### Comparative Examples 1 to 5

(Preparation of Hologram Recording Compositions 101 to 105)

In Comparative Example 1, a hologram recording composition 101 was obtained according to the amounts illustrated in Table 2 in a similar manner to Example 1 using similar materials to those in Example 1 except that non-epoxy-based diethyl sebacate (“SDE” manufactured by Wako Pure Chemical Industry, Ltd.) was used as a plasticizer.

In Comparative Example 2, a hologram recording composition 102 was obtained according to the amounts illustrated in Table 2 in a similar manner to Example 1 using similar materials to those in Example 1 except that tetrabutylammonium=butyltriphenylborate (“P3B” manufactured by Showa Denko K.K.) was not used out of the polymerization initiators.

In Comparative Example 3, a hologram recording composition 103 was obtained according to the amounts illustrated in Table 2 in a similar manner to Example 1 using similar materials to those in Example 1 except that 4-isopropyl-4′-methyldiphenyliodonium tetrakis(pentafluorophenyl) borate (“10591” manufactured by Tokyo Chemical Industry Co., Ltd.) was not used out of the polymerization initiators.

In Comparative Example 4, a hologram recording composition 104 was obtained according to the amounts illustrated in Table 2 in a similar manner to Example 1 using similar materials to those in Example 5 except that non-epoxy-based diethyl sebacate (“SDE” manufactured by Wako Pure Chemical Industry, Ltd.) was used as a plasticizer.

In Comparative Example 5, a hologram recording composition 105 was obtained according to the amounts illustrated in Table 2 in a similar manner to Example 1 using similar materials to those in Example 1 except that non-epoxy-based diethyl sebacate (“SDE” manufactured by Wako Pure Chemical Industries, Ltd.) was used as a plasticizer, and 3,3′-diethyloxacarbocyanine iodide (“DEOCYI” manufactured by SIGMA ALDRICH) was used as a chromic dye whose decolorized body has a structure containing no primary or secondary amino group but containing only a tertiary amino group.

(Preparation of Hologram Recording Media 101 to 105)

Hologram recording media 101 to 105 were prepared in a similar manner to Example 1 using the above hologram recording compositions 101 to 105, respectively.

(Preparation of holograms 101 to 105)

Holograms 101 to 105 were prepared in a similar manner to Example 1 using the above hologram recording media 101 to 105, respectively.

(Evaluation of Holograms 101 to 105)

The refractive index modulation amount (Δn), the transparency, and the retention of diffraction characteristics of each of the prepared holograms 101 to 105 were evaluated in a similar manner to Example 1.

<Experimental Results>

Tables 1 and 2 illustrate experimental results of the holograms in Examples 1 to 5 and Comparative Examples 1 to 5 described above. Note that in Tables 1 and 2, the numerical values of the components are illustrated in terms of % by mass.

TABLE 1

| | | Example 1 | Example 2 | Example 3 | Example 4 | Example 5 |
|---|---|---|---|---|---|---|
| Composition | Radically | | | | | |
| | polymerizable monomer | | | | | |
| | EA-0200 | 36.80 | 36.80 | 36.80 | 36.80 | 36.80 |
| | EACz | 8.20 | 8.20 | 8.20 | 8.20 | 8.20 |
| | Binder resin | | | | | |
| | SN-09T | 19.38 | — | — | — | 19.38 |
| | SN-55T | — | 19.38 | 19.38 | — | — |
| | SN-77T | — | — | — | 19.38 | — |
| | Plasticizer | | | | | |
| | EX212L | 30.00 | 30.00 | 30.00 | 30.00 | 30.00 |
| | Chromic dye | | | | | |
| | MB | 1.88 | 1.88 | 0.94 | — | — |
| | SFO | — | — | — | 0.23 | — |
| | AOG | — | — | — | — | 2.34 |
| | Polymerization initiator | | | | | |
| | I0591 | 5.97 | 5.97 | 11.94 | 11.94 | 8.43 |
| | P3B | 3.18 | 3.18 | 1.59 | 3.18 | 3.42 |
| | Chain transfer agent | | | | | |
| | 2-MBO | 0.14 | 0.14 | 0.14 | — | 0.56 |
| | Polymerization inhibitor | | | | | |
| | PT | 0.22 | 0.22 | 0.22 | 0.22 | 0.08 |
| | UV sensitizing dye | | | | | |
| | UVS1331 | 7.76 | 7.76 | 7.76 | 7.76 | 1.39 |
| Exposure | Wavelength [nm] | 660 | 660 | 660 | 532 | 457 |
| condition | Exposure amount [mJ/cm²] | 510 | 510 | 510 | 174 | 84 |
| Evaluation | Refractive index | 0.062 | 0.049 | 0.043 | 0.041 | 0.051 |
| | modulation amount (Δn) | | | | | |
| | Transparency | ∘ | ∘ | ∘ | ∘ | ∘ |
| | Retention of diffraction | ∘ | ∘ | ∘ | ∘ | ∘ |
| | characteristics | | | | | |

TABLE 2

| | | Comparative | Comparative | Comparative | Comparative | Comparative |
|---|---|---|---|---|---|---|
| | | Example 1 | Example 2 | Example 3 | Example 4 | Example 5 |
| Composition | Radically | | | | | |
| | polymerizable monomer | | | | | |
| | EA-0200 | 36.80 | 36.80 | 36.80 | 36.80 | 36.80 |
| | EACz | 8.20 | 8.20 | 8.20 | 8.20 | 8.20 |
| | Binder resin | | | | | |
| | SN-09T | 19.38 | 19.38 | 19.38 | 19.38 | 19.38 |
| | Plasticizer | | | | | |
| | SDE | 30.00 | — | — | 30.00 | — |
| | EX212L | — | 30.00 | 30.00 | — | 30.00 |
| | Chromic dye | | | | | |
| | MB | 1.88 | 1.88 | 1.88 | — | — |
| | AOG | — | — | — | 2.34 | |
| | DEOCY1 | — | — | — | — | 2.34 |
| | Polymerization initiator | | | | | |
| | I0591 | 5.97 | 5.97 | — | 8.43 | 8.43 |
| | P3B | 3.18 | — | 3.18 | 3.42 | 3.42 |
| | Chain transfer agent | | | | | |
| | 2-MBO | 0.14 | 0.14 | 0.14 | 0.56 | 0.56 |
| | Polymerization inhibitor | | | | | |
| | PT | 0.22 | 0.22 | 0.22 | 0.08 | 0.08 |
| | UV sensitizing dye | | | | | |
| | UVS1331 | 7.76 | 7.76 | 7.76 | 1.39 | 1.39 |
| Exposure | Wavelength [nm] | 660 | 660 | 660 | 457 | 457 |
| condition | Exposure amount [mJ/cm²] | 510 | 510 | 510 | 84 | 84 |
| Evaluation | Refractive index | 0.058 | 0.01 | 0.041 | 0.051 | 0.041 |
| | modulation amount (Δn) | | | | | |
| | Transparency | x | x | ∘ | x | x |
| | Retention of diffraction | x | ∘ | x | ∘ | ∘ |
| | characteristics | | | | | |

By referring to Example 1 and Comparative Example 1, and Example 5 and Comparative Example 4, it has been found that use of an epoxy monomer as a plasticizer improves the transparency and the retention of diffraction characteristics.

Furthermore, by referring to Example 1 and Comparative Examples 2 and 3, it has been found that use of an onium salt-based initiator and an aryl borate salt-based initiator as polymerization initiators further improves the refractive index modulation amount (Δn), the transparency, and the retention of diffraction characteristics.

Moreover, by referring to Example 5 and Comparative Example 5, it has been found that use of a chromic dye whose decolorized body has a structure containing a primary and/or secondary amino group improves the refractive index modulation amount (Δn) and the transparency.

As described above, according to the present technology, by combining a chromic dye whose decolorized body has a structure containing a primary and/or secondary amino group, an epoxy monomer, and a polymerization initiator, a hologram having a high refractive index modulation amount (Δn) and excellent transparency and retention of diffraction characteristics after exposure can be obtained without going through a heating step after exposure.

### REFERENCE SIGNS LIST

1 Hologram recording medium
11 Transparent protective film (transparent base material)
12 Photosensitive layer
13 Glass or film substrate (transparent base material)

1. A hologram recording composition comprising at least a chromic dye whose decolorized body has a structure containing a primary and/or secondary amino group, an epoxy monomer, and a polymerization initiator.

2. The hologram recording composition according to claim 1, wherein the chromic dye is a dye that is decolorized by pH and/or redox.

3. The hologram recording composition according to claim 1, comprising two or more of the polymerization initiators.

4. The hologram recording composition according to claim 1, wherein the polymerization initiator contains one or more onium salt-based initiators.

5. The hologram recording composition according to claim 1, wherein the polymerization initiator contains one or more onium salt-based initiators and one or more non-onium salt-based initiators.

6. The hologram recording composition according to claim 1, wherein the polymerization initiator contains one or more onium salt-based initiators and one or more aryl borate salt-based initiators.

7. The hologram recording composition according to claim 1, wherein the chromic dye is at least one selected from the group consisting of a thiazine-based compound, an azine-based compound, an acridine-based compound, an oxazine-based compound, and a cyanine-based compound.

8. A hologram recording medium comprising a photosensitive layer containing at least a chromic dye whose decolorized body has a structure containing a primary and/or secondary amino group, an epoxy monomer, and a polymerization initiator.

9. The hologram recording medium according to claim 8, wherein the chromic dye is a dye that is decolorized by pH and/or redox.

10. The hologram recording medium according to claim 8, wherein the photosensitive layer contains two or more of the polymerization initiators.

11. The hologram recording medium according to claim 8, wherein the polymerization initiator contains one or more onium salt-based initiators.

12. The hologram recording medium according to claim 8, wherein the polymerization initiator contains one or more onium salt-based initiators and one or more non-onium salt-based initiators.

13. The hologram recording medium according to claim 8, wherein the polymerization initiator contains one or more onium salt-based initiators and one or more aryl borate salt-based initiators.

14. The hologram recording medium according to claim 8, wherein the chromic dye is at least one selected from the group consisting of a thiazine-based compound, an azine-based compound, an acridine-based compound, an oxazine-based compound, and a cyanine-based compound.

15. A hologram optical element using the hologram recording medium according to claim 8.

16. An optical device using the hologram optical element according to claim 15.

17. An optical component using the hologram optical element according to claim 15.

18. A method for forming a hologram diffraction grating, the method comprising causing a hologram recording medium including a photosensitive layer containing at least a chromic dye whose decolorized body has a structure containing a primary and/or secondary amino group, an epoxy monomer, and a polymerization initiator to react selectively by an electromagnetic beam having a spatially modulated amplitude.
